(19) United States
(12) Patent Application Publication
(10) Pub. No.: US 2024/0004633 A1
(43) Pub. Date: Jan. 4, 2024

(54) ELECTRONIC CONTROL DEVICE

(71) Applicant: HITACHI ASTEMO, LTD., Hitachinaka-shi, Ibaraki (JP)

(72) Inventors: Shun KINUGASA, Hitachinaka-shi, Ibaraki (JP); Kosuke SUMIYA, Hitachinaka-shi, Ibaraki (JP); Yusuke ABE, Hitachinaka-shi, Ibaraki (JP); Atsushi HIRONAKA, Hitachinaka-shi, Ibaraki (JP)

(73) Assignee: HITACHI ASTEMO, LTD., Hitachinaka-shi, Ibaraki (JP)

(21) Appl. No.: 18/254,447

(22) PCT Filed: Aug. 31, 2021
(86) PCT No.: PCT/JP2021/031850

§ 371 Date: May 25, 2023

(30) Foreign Application Priority Data
Dec. 16, 2020 (JP) 2020-208346

(51) Int. Cl. G06F 8/65; H04L 9/40

(52) U.S. Cl. CPC G06F 8/65; H04L 63/0428

(57) ABSTRACT

The purpose of the present invention is to provide technology whereby a retransmission start address can be properly identified even when update data is compressed or encrypted. In the electronic control device according to the present invention, update data includes at least one of compressed data and encrypted data and includes unprocessed data that is neither compressed nor encrypted, and the unprocessed data retains an address list that can identify the positions of data blocks included in the update data.

### TECHNICAL FIELD

The present invention relates to an electronic control device mounted on a vehicle.

### BACKGROUND ART

An in-vehicle electronic control device such as an electrical control unit (ECU) is controlled by a microcomputer. Various functions are assigned to the microcomputer, and external circuits corresponding thereto are provided. The ECU controls the target device by executing control software stored in a flash read only memory (ROM) which is a nonvolatile memory. In an automobile, for example, fuel injection and ignition of an engine are controlled.

The ECU generally has means for rewriting control software written in a memory mounted on the ECU. For example, there are the following means: (1) a system in which a diagnosis tool is connected to an ECU in a wired manner via an on-board diagnostic (OBD) connector, and data to be written in a flash ROM is transmitted by a signal of a controller area network (CAN) or the like (conventional system); and (2) a system for transmitting update version data to an ECU through over-the-air (OTA) wireless communication.

In the software rewriting by the OTA, the update version data may be received while the vehicle is traveling. In this method, it is necessary to transfer data little by little in the background so as not to affect other control being executed. At this time, the software rewriting time becomes long, and the process may be interrupted due to a factor such as power supply being cut off by the user, for example. In such a case, a resume function that starts from the middle even if the software rewriting is interrupted is required.

The following PTL 1 describes a resume function of software rewriting. In this literature, a software rewriting start address is requested from a data transfer source to an ECU after interruption of software rewriting.

### CITATION LIST

### Patent Literature

PTL 1: JP 2017-097576 A

### SUMMARY OF INVENTION

### Technical Problem

In the technique described in PTL 1, it is necessary to hold a position of a data block requesting retransmission on the ECU side. Therefore, it is considered that the address in the ROM data held by the ECU and the address in the ROM data transmitted from the server or the like are assumed to be the same.

On the other hand, in the software rewriting of the ECU, the ROM data to be transmitted may be compressed or encrypted, or both. The compression of the ROM data contributes to shortening of a communication time in software rewriting, and the encryption contributes to security enhancement. However, in any case, it may be difficult to specify relative and absolute addresses as compared with raw ROM data that has not been subjected to any processing of compression and encryption.

The present invention has been made in view of the above problems, and an object of the present invention is to provide a technique capable of appropriately specifying a retransmission start address even when update data is compressed or encrypted.

### Solution to Problem

In the electronic control device according to the present invention, update data includes at least one of compressed data or encrypted data and includes non-processed data that is not compressed or encrypted, and the non-processed data holds an address list that can specify a position of each data block included in the update data.

### Advantageous Effects of Invention

According to the electronic control device of the present invention, even when the update data is compressed or encrypted, the retransmission start address can be appropriately specified.

### BRIEF DESCRIPTION OF DRAWINGS

FIG. 1 is a configuration diagram of an electronic control device (ECU) 1 according to a first embodiment.

FIG. 2 is a schematic diagram illustrating a state in which update data 3 is encrypted.

FIG. 3 is a configuration diagram of a global header 31.

FIG. 4 is a flowchart for explaining resume processing in program update.

FIG. 5 is a flowchart for explaining a process in which an update data transmission unit 2 transmits update data 4.

FIG. 6 is a flowchart for explaining details of S408.

FIG. 7 is a flowchart for explaining details of S603.

FIG. 8 is a configuration diagram of an ECU 1 according to a second embodiment.

FIG. 9 is a configuration diagram of an ECU 1 according to a third embodiment.

FIG. 10 is a configuration diagram of an ECU 1 according to a fourth embodiment.

### DESCRIPTION OF EMBODIMENTS

### First Embodiment

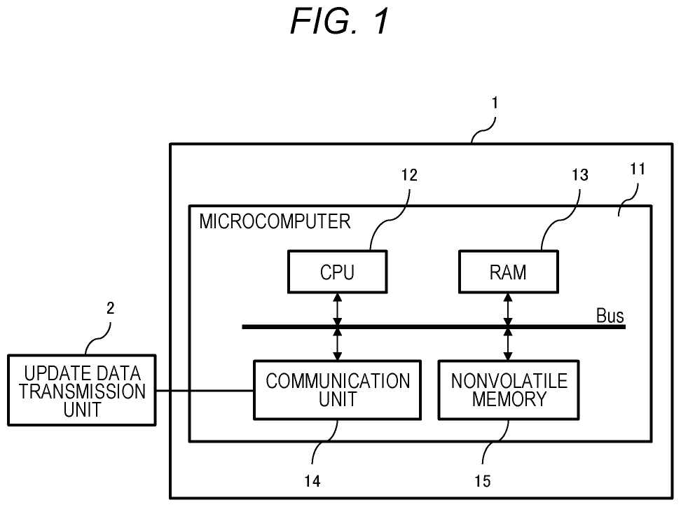

FIG. 1 is a configuration diagram of an electronic control device (ECU) 1 according to a first embodiment of the present invention. The ECU 1 is mounted on a vehicle. The ECU 1 controls devices mounted on the vehicle. Examples of the in-vehicle device include an engine, a power steering device, a control brake device, and the like. The ECU 1 controls the in-vehicle devices by executing a control program in which a process of controlling the in-vehicle devices is mounted.

The ECU 1 includes a microcomputer 11. The microcomputer 11 includes at least one central processor unit (CPU) 12 that executes software, at least one volatile random access memory (RAM) 13, at least one nonvolatile memory 15 that holds programs and data, and at least one communication unit 14. The communication unit 14 is connected to an update data transmission unit 2 outside the ECU 1, and receives update data via the update data transmission unit 2 at the time of program update.

The update data transmission unit 2 may be, for example, a terminal for program update preferentially connected to a data communication connector of a vehicle, or may be a server computer that communicates with the ECU 1 by wireless communication. Alternatively, another ECU mounted on the same vehicle may be used.

FIG. 2 is a schematic diagram illustrating a state in which update data 3 is encrypted. The update data 3 is data including an update version of a program or the like executed by the ECU 1. The update data 3 is transmitted from a data center or the like to the ECU 1 by wireless communication, for example. The update data 3 is configured as, for example, binary data itself stored in the nonvolatile memory 15.

The update data 3 includes a global header 31 and one or more data blocks (FIG. 2 illustrates data blocks 32, 33, and 3N). The data block includes a local header portion and a body portion (for example, the data block 32 includes a local header 321 and a body 322). The size of each data block may be the same or different.

The body portion of the data block is compressed before being transmitted to the ECU 1. The local header portion is not compressed. A local header is given to the compressed body portion. The update data 3 is created by concatenating a pair of a local header and a body to form one piece of data and further adding the global header 31. The local header describes supplementary information of the data block, and the global header describes supplementary information of the entire update data 3. Details of these headers will be described later.

The update data 3 is encrypted before being transmitted to the ECU 1 and becomes update data 4. The update data 4 includes an encrypted data block (FIG. 2 illustrates data blocks 42, 43, and 4N). The global header 31 is assigned as it is without being encrypted. Although block encryption is used as the encryption algorithm in the present embodiment, another algorithm may be used. When the block encryption algorithm is used, the update data 4 is encrypted for each data block, and then encrypted for each block of a certain size.

The local header may or may not be encrypted. That is, as described later, it is sufficient that a correspondence between each data block in the update data 4 and a storage address of each data block on the nonvolatile memory 15 can be specified. In other words, this correspondence may be described in the global header 31 or may be described in each local header. In the former case, by describing the start address of each data block in the update data 4 in the global header 31, the ECU 1 can specify the correspondence between each data block in the update data 4 and the storage destination address in the nonvolatile memory 15, and thus, may encrypt each local header. In the latter case, each local header describes the location of the next local header in the update data 4, and by continuing this, the location of each data block in the update data 4 is determined. The local header of a data block describes information that can specify a location (address) in the nonvolatile memory 15 where the data block is to be stored. As a result, the ECU 1 can specify the correspondence between each data block in the update data 4 and the storage destination address in the nonvolatile memory 15. In either case, the global header 31 is not encrypted.

The local header is not necessarily disposed at the head of the data block, and may be disposed at the end of the data block, for example, or may be disposed at an arbitrary position between the head and the end. As a method in which the local header specifies the position of the next data block, the head of the body of the next data block may be specified, or the local header of the next data block (only when the local header is disposed at the head of the data block) may be specified.

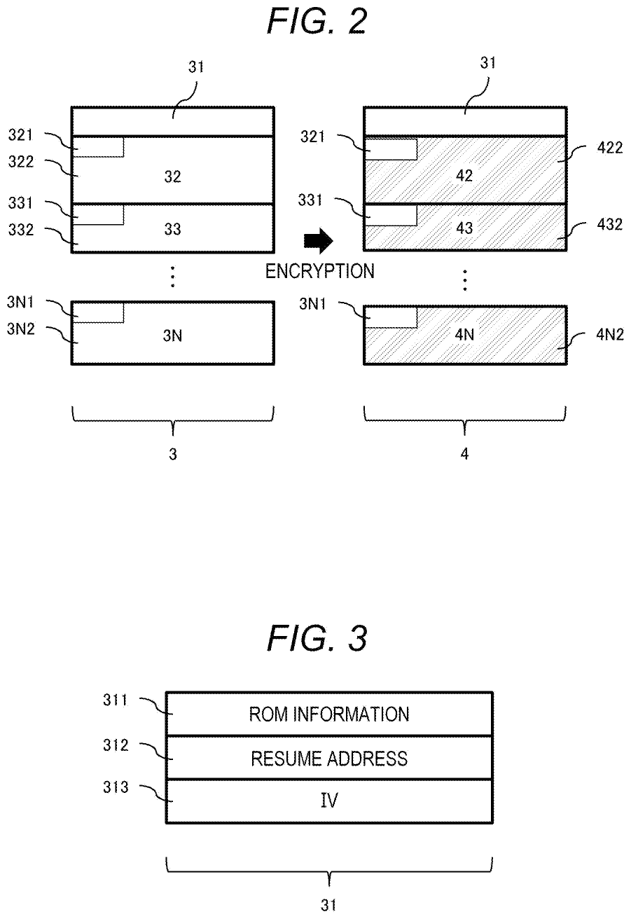

FIG. 3 is a configuration diagram of the global header 31. The global header 31 includes ROM information 311, a resume address 312, and an initial vector (IV) 313. Here, an example in which the relationship between the data block and the storage destination address in the nonvolatile memory 15 (that is, the resume address 312) is stored in the global header 31 has been described.

The ROM information 311 is information such as the number of blocks constituting the update data 3, the size of the update data 3, and a code indicating a compression/encryption algorithm. The resume address 312 describes a correspondence between a head address of each data block in the update data 3 and an address at which the data block in the nonvolatile memory 15 is written. The address itself in the nonvolatile memory 15 may be described, or other information that can specify the address in the nonvolatile memory 15 may be described. The IV 313 is information necessary for decrypting the first encrypted data block (the data block 42 in FIG. 2) in the block encryption. The ROM information 311 and the resume address 312 may be included in the local header. The IV 313 may not be included in the global header 31 and may be stored in the nonvolatile memory 15 in advance.

As the address in the update data 3 described by the global header 31, the same value is used in the update data 4 (since the global header 31 is common between the update data 3 and 4). Therefore, when the update data 3 is encrypted, it is desirable not to change the size of each data block. For example, it is desirable to use an encryption algorithm that does not change the size of the data block. Block encryption is one example. On the other hand, when the update data 3 is encrypted, in a case where the size of each data block changes, it is necessary to reflect the change on the resume address 312.

A part or all of each piece of information in the global header 31 is transmitted to the ECU 1 via the update data transmission unit 2 and then stored in the nonvolatile memory 15. In the present embodiment, when the ECU 1 receives the update data 4, the resume address 312 is stored in the nonvolatile memory 15, and other information in the global header 31 is not stored, but instead of or in addition to this, for example, the IV 313 may be stored in the nonvolatile memory 15.

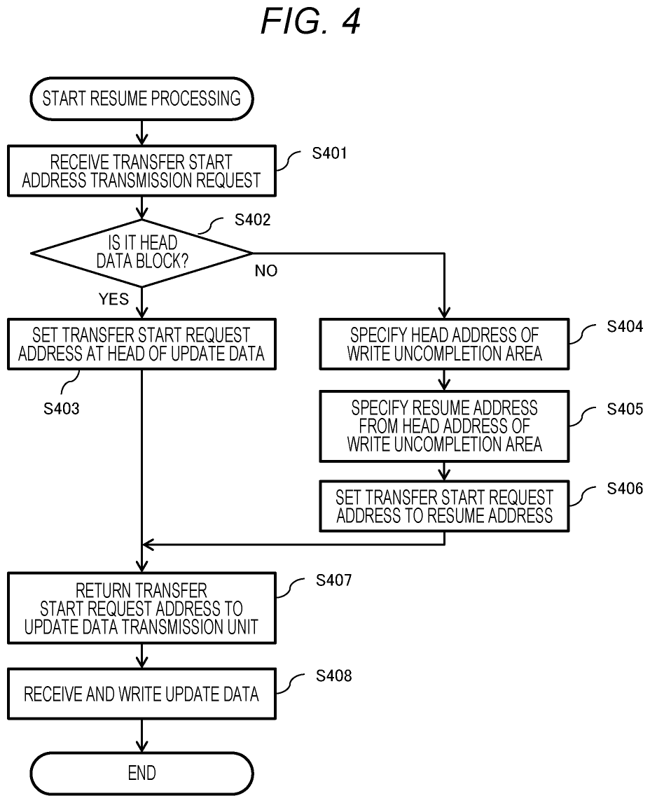

FIG. 4 is a flowchart for explaining resume processing in program update. Each step of FIG. 4 will be described below.

### (FIG. 4: Step S401)

When the resume processing is started, the update data transmission unit 2 requests the ECU 1 to transmit a transfer start address of the update data 4. The transfer start address is an address that designates from which part of the update data 4 is to be retransmitted to the ECU 1, for example, when the process of writing the update data 4 to the nonvolatile memory 15 is interrupted in the middle. When the processing is not interrupted in the middle, the head address may be designated.

### (FIG. 4: Step S402)

The CPU 12 determines whether a data block to be first written to the nonvolatile memory 15 is a head data block of the update data 4. This determination can be performed by referring to write completion block information described later. When the head data block is to be written, the process proceeds to S403, and when the data block other than the head data block is to be written, the process proceeds to S404.

### (FIG. 4: Steps S403, S407)

The CPU 12 sets a transfer start request address at the head of the update data 4 (S403). The CPU 12 returns the transfer start request address to the update data transmission unit 2 (S407).

### (FIG. 4: Steps S404 to S406, S407)

The CPU 12 specifies the head address of the area in which the writing of the data block in the nonvolatile memory 15 is not completed according to the write completion block information (S404). The CPU 12 specifies the corresponding address in the update data 4 according to the specified address (S405). This address is a resume address of the update data 4. The correspondence between the address in the nonvolatile memory 15 and the address in the update data 4 may be stored in the nonvolatile memory 15 in advance, for example. Alternatively, the correspondence may be held in advance in the update data transmission unit 2, and the CPU 12 may specify the address in the nonvolatile memory 15 as the resume address and specify the corresponding address in the update data 4 according to the correspondence in the update data transmission unit 2. The CPU 12 sets the resume address as the transfer start request address (S406). The CPU 12 returns the transfer start request address to the update data transmission unit 2 (S407).

### (FIG. 4: Step S405: Supplement)

The position of the data block in the update data 4 may be specified by an address in the update data 4, or may be specified by information other than the address, such as a number of the data block. That is, at least information that can specify a correspondence between a data block in the update data 4 and a position in the nonvolatile memory 15 may be shared between the update data transmission unit 2 and the ECU 1.

### (FIG. 4: Step S408)

When receiving the transfer start request address from the ECU 1, the update data transmission unit 2 transmits a portion of the update data 4 after the transfer start request address to the ECU 1. The CPU 12 receives the update data 4 and writes the update data in the nonvolatile memory 15. Details of this step will be described later.

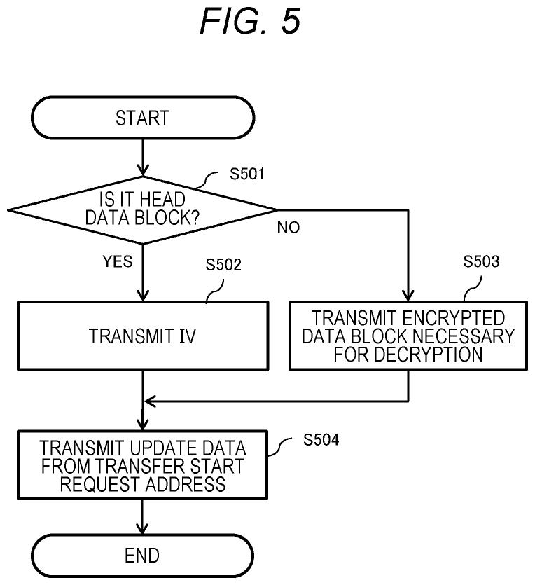

FIG. 5 is a flowchart for explaining a process in which the update data transmission unit 2 transmits the update data 4. When receiving the transfer start request address from the ECU 1, the update data transmission unit 2 starts this flowchart. Each step of FIG. 5 will be described below.

### (FIG. 5: Step S501)

The update data transmission unit 2 determines whether the transfer start request address is an encrypted data block of the head of the update data 4. If it is the head, the process proceeds to S502, and if it is not the head, the process proceeds to S503.

### (FIG. 5: Step S502)

The update data transmission unit 2 transmits the IV 313 used to decrypt the encrypted data block of the head of the update data 4 to the ECU 1.

### (FIG. 5: Step S503)

The update data transmission unit 2 transmits another encrypted data block used for decrypting the data block of the update data 4 to the ECU 1. Typically, when a data block is encrypted, encryption is performed using a previous encrypted data block. Therefore, the update data transmission unit 2 transmits the encrypted data block immediately before the data block designated by the transfer start request address to the ECU 1.

### (FIG. 5: Step S504)

The update data transmission unit 2 sequentially transmits data blocks designated by the transfer start request address to the ECU 1. The ECU 1 can decrypt the data block received first by using the data block received in S502 or S503. For subsequent data blocks, the previously received data block is temporarily stored in the RAM 13 or the like, and decryption can be performed using the data block. When a data block other than the previously received data block is used in decryption, the data block used for decryption may be temporarily stored in the RAM 13 or the like.

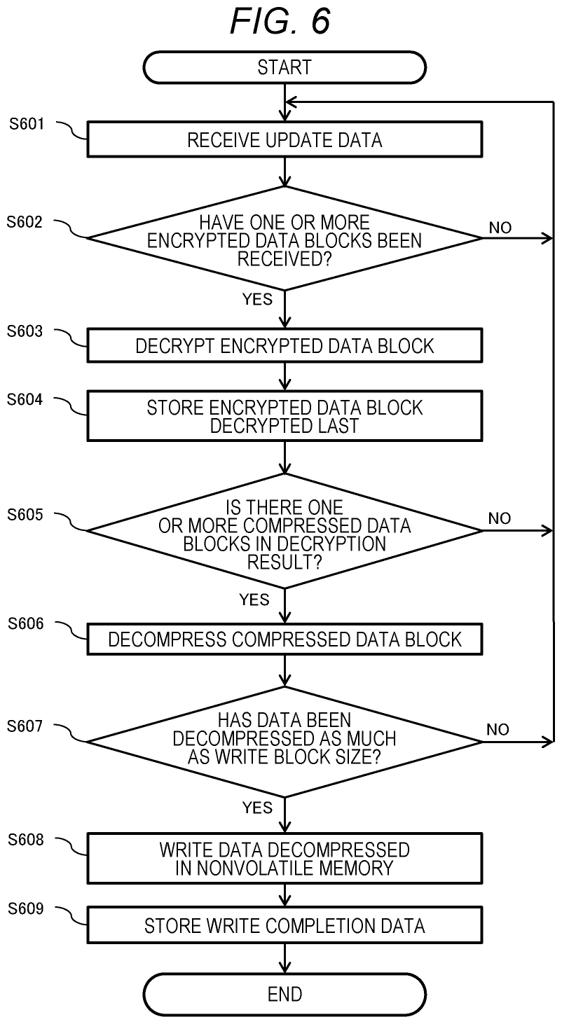

FIG. 6 is a flowchart for explaining details of S408. Hereinafter, each step of FIG. 6 will be described.

### (FIG. 6: Step S601)

The communication unit 14 receives the update data 4 from the update data transmission unit 2. The CPU 12 stores the global header 31 (ROM information 311, resume address 312, IV 313) included in the update data 4 in the RAM 13 or the nonvolatile memory 15.

### (FIG. 6: Step S602)

The CPU 12 determines whether one or more encrypted data blocks have been received. For example, this determination can be performed on the basis of whether the data received from the update data transmission unit 2 has reached the size of the encrypted data block. When one or more encrypted data blocks have been received, the process proceeds to S603, and when one or more encrypted data blocks have not been received, the process returns to S601 to continue to receive data.

### (FIG. 6: Step S603)

The CPU 12 decrypts the received encrypted data block. The decrypted data is developed in the RAM 13 or the nonvolatile memory 15. Details of the decryption processing of this step will be described later.

### (FIG. 6: Step S604)

The CPU 12 stores the encrypted data block, which has been decrypted last, in the RAM 13 or the nonvolatile memory 15 in order to use the data block for decryption of the next encrypted data block.

### (FIG. 6: Step S605)

The CPU 12 determines whether one or more compressed data blocks are included in the decrypted data. For example, when the decrypted data size is less than one compressed data block, it can be determined that there is no compressed data block. When the compressed data block is not included, the process returns to S601 to continue to receive the data. When the compressed data block is included, the process proceeds to S606.

### (FIG. 6: Step S606)

The CPU 12 decompresses the compressed data block.

### (FIG. 6: Step S607)

The CPU 12 determines whether the decompressed data has reached the write block size of the nonvolatile memory 15. If not, the process returns to step S601 to continue to receive data. In a case where it has reached the size, the process proceeds to S608.

### (FIG. 6: Steps S608 to S609)

The CPU 12 writes the decompressed data in the nonvolatile memory 15 (S608). The CPU 12 stores the write completion data block information indicating that the writing of the data block is completed in the nonvolatile memory 15 (S609).

### (FIG. 6: Step S609: Supplement)

The write completion data block information can also be used to check the consistency of the written data block. For example, the CPU 12 may determine whether the writing of the data block is normally completed by performing error correction processing or the like using the write completion data block information.

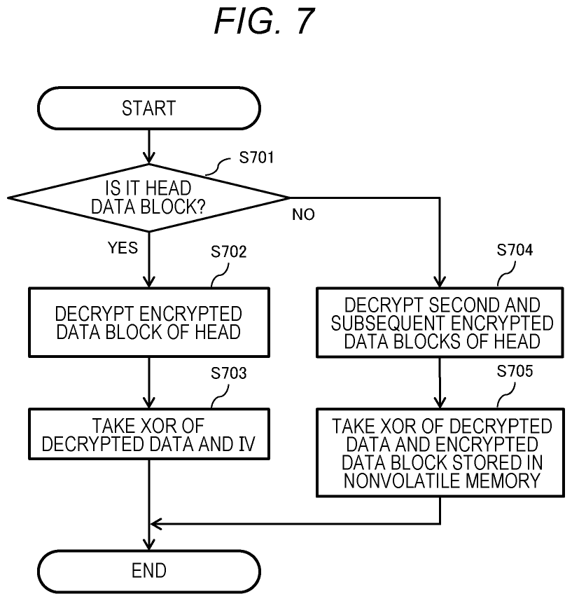

FIG. 7 is a flowchart for explaining details of S603. In the present embodiment, an AES-CBC (Advanced Encryption Standard-Cipher Block Chaining) mode is used for the encryption processing and the decryption processing, but the present invention is not limited thereto, and another algorithm may be used. Hereinafter, each step of FIG. 7 will be described.

### (FIG. 7: Step S701)

The CPU 12 determines whether the data block to be decrypted is the first encrypted data block (the data block 42 in the example of FIG. 2) in the update data 4. When the first encrypted data block is to be decrypted, the process proceeds to S702, and when the second and subsequent encrypted data blocks are to be decrypted, the process proceeds to S704.

### (FIG. 7: Step S702)

The CPU 12 decrypts the first encrypted data block in the update data 4. For example, the same decryption key as that used in the encryption processing for generating the encrypted data block is used. The decryption key may be stored in the nonvolatile memory 15 in advance, or may be transmitted to the ECU 1 by another secure method.

### (FIG. 7: Step S703)

The CPU 12 can generate a plaintext block called a plain text by taking an exclusive OR (XOR) of the decrypted encrypted data block and the IV 313 saved in the nonvolatile memory 15 in S408 of FIGS. 4. S702 and S703 may be collectively regarded as decryption processing in a broad sense. The same applies to S704 and S705.

### (FIG. 7: Step S704)

The CPU 12 decrypts the second and subsequent encrypted data blocks in the update data 4. The decryption key is similar to that in S702.

### (FIG. 7: Step S705)

The CPU 12 can generate a plaintext block by performing XOR between the decrypted encrypted data block and the encrypted data block stored in the nonvolatile memory 15 in S604 of FIG. 6.

### Second Embodiment

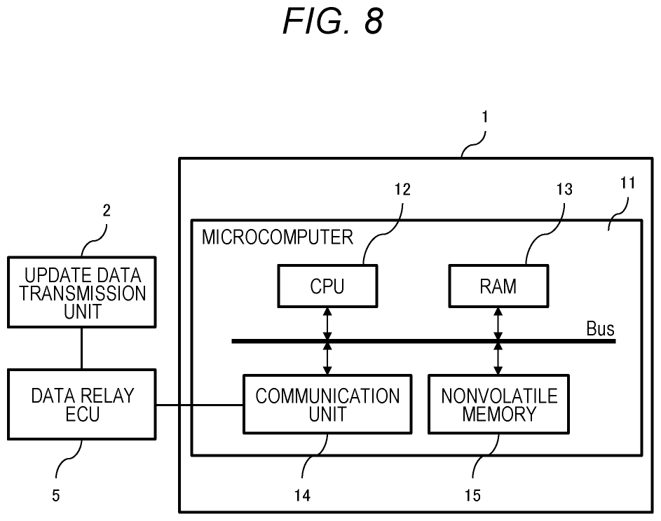

FIG. 8 is a configuration diagram of an ECU 1 according to a second embodiment of the present invention. When the ECU 1 receives the update data 4 from the update data transmission unit 2, a data relay ECU 5 may relay the update data 4. For example, the data relay ECU 5 is a gateway device disposed between the ECU 1 and the update data transmission unit 2, and can be mounted in the same in-vehicle network as the ECU 1. When receiving the update data 4, the data relay ECU 5 temporarily stores a copy of the update data. The data relay ECU 5 does not decrypt or decompress the update data 4.

When the data relay ECU 5 can receive all the update data 4 without delay, the update data transmission unit 2 in the first embodiment is replaced with the data relay ECU 5, and the resume can be realized by the same method as in the first embodiment.

When an abnormality occurs while the data relay ECU 5 is storing the update data 4, the update data 4 may be retransmitted between the update data transmission unit 2 and the data relay ECU 5. Since the data relay ECU 5 does not decrypt or decompress the update data 4, a retransmission start address may be simply set immediately after the address range that can be stored in the data relay ECU 5.

### Third Embodiment

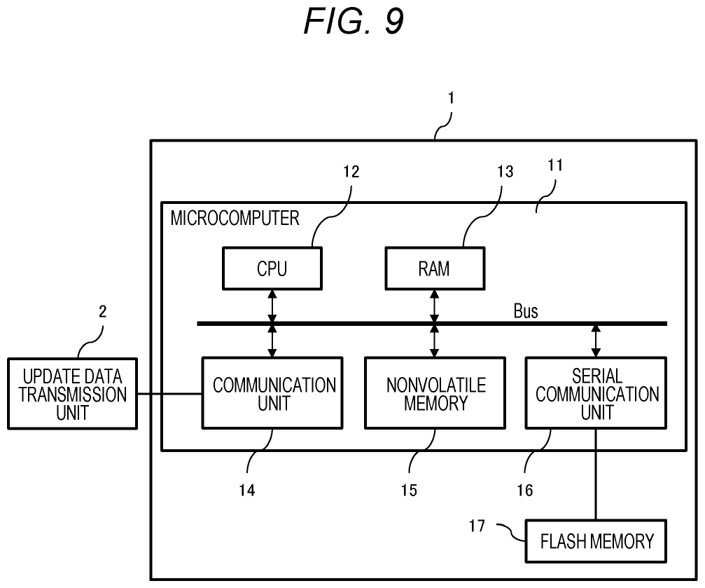

FIG. 9 is a configuration diagram of an ECU 1 according to a third embodiment of the present invention. The update data 4 may be stored in a non-volatile storage device such as a flash memory 17 disposed outside the microcomputer 11 instead of the nonvolatile memory 15. In this case, the microcomputer 11 accesses the flash memory 17 via an interface such as a serial communication unit 16 and writes a data block obtained by decrypting and decompressing the update data 4.

### Fourth Embodiment

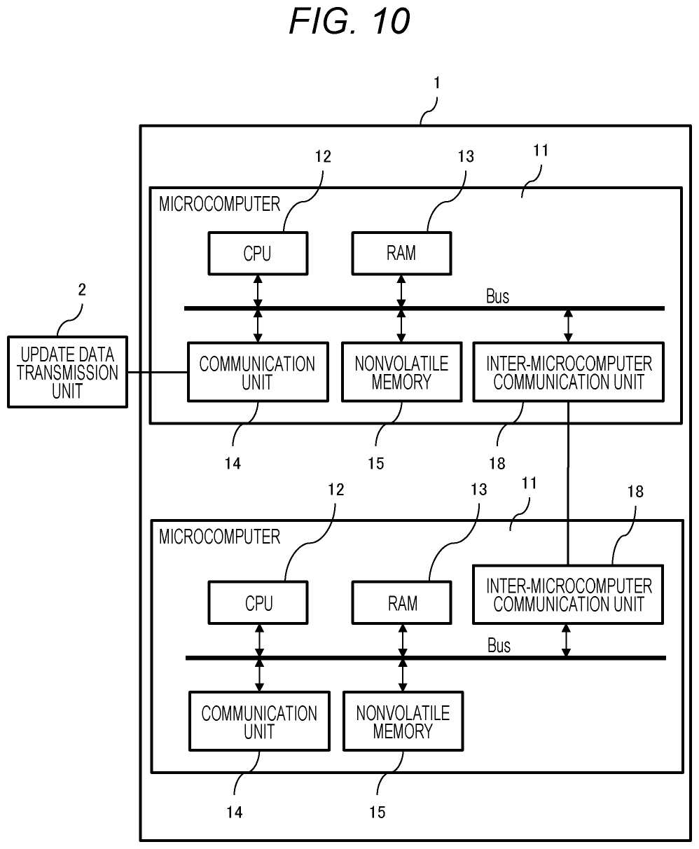

FIG. 10 is a configuration diagram of an ECU 1 according to a fourth embodiment of the present invention. The present invention can also be applied to a case where the ECU 1 includes two or more microcomputers 11 as illustrated in FIG. 10. Specifically, one of the microcomputers 11 receives the update data 4. The data block obtained from the update data 4 by decompression and decryption is shared by the other microcomputers 11 via an inter-microcomputer communication unit 18.

### CONCLUSIONS

An ECU 1 according to the first to fourth embodiments is an electronic control device mounted on a vehicle, the electronic control device including: a calculation unit configured to execute a program in which a process of controlling a device mounted on the vehicle is mounted; a communication unit configured to receive update data used to update the program; and a storage unit configured to store the program. The update data includes at least one of compressed data subjected to compression processing or encrypted data subjected to encryption processing, and includes non-processed data not subjected to compression processing or encryption processing. The calculation unit extracts an update version data block of the program to be written to the storage unit from the update data by at least performing one of decompressing the compressed data and decrypting the encrypted data. The non-processed data holds an address list describing information capable of specifying each data block included in the update data. When the process of writing the update version data block to the storage unit is interrupted in a middle, the calculation unit specifies a data block in the update data corresponding to the update version data block to be rewritten according to the address list, and designates the specified data block to re-acquire the update data. Since the information of the retransmission request address is included in the non-processed data on which neither the compression processing nor the encryption processing is performed, the retransmission request address can be specified without performing the decompression processing or the decryption processing. This facilitates restart of the write processing.

In such an ECU 1, the non-processed data may include a header portion of a head of the update data. The address list may be included in the header portion. The calculation unit may acquire the address list from the header portion to specify a data block in the update data corresponding to the update version data block to be rewritten. Since the retransmission request address of each data block is collectively included in the global header, and the global header is transmitted at the beginning of the entire update data, the retransmission request address has been transmitted even when the writing of any data block is resumed when the write processing is resumed. Therefore, the retransmission request address can be reliably specified.

In the ECU 1, the electronic control device may further include a memory that stores the address list. The calculation unit may store the address list acquired from the header portion in the memory when writing the update version data block in the storage unit. The calculation unit may specify a data block in the update data corresponding to the update version data block to be rewritten using the address list stored in the memory when a process of writing the update version data block into the storage unit is interrupted in a middle. Even in a case where the cause of interruption of the write processing is interruption of the power supply, the retransmission request address is stored in the data flash. Therefore, even when the power supply is shut off, the transmitted retransmission request address is not lost.

In the ECU 1, the update data may include one or more data blocks. The non-processed data may include a header portion at a head of the data block. The address list may be included in the header portion. The calculation unit may acquire the address list from the header portion to specify a data block in the update data corresponding to the update version data block to be rewritten. Even when the write processing of any data block is interrupted, since the local header of this data block has been transmitted, the retransmission request address can be specified.

In the ECU 1, the data block may be subjected to the compression processing. A header portion of the data block may be not compressed. By performing the compression processing after the data block is divided into the plurality of data blocks, a higher compression effect can be obtained (compression rate is high). In addition, since the header region that is unprocessed data is added after the compression processing, the header region is not affected by the compression processing.

In the ECU 1, the calculation unit may acquire the update version data block by decompressing the update data for each data block. The calculation unit may write the update data into the storage unit for each update version data block. Since the decompression processing and the write processing are performed for each block, it is not necessary to hold a large amount of decompressed data waiting for the write processing, and an increase in memory load can be suppressed.

In the ECU 1, the update data may be configured by aggregating one or more of the data blocks subjected to the compression processing and the header portion corresponding to the data block. The update data may be subjected to the encryption processing for each of the data blocks. The header portion may be not encrypted. As a result, it is possible to transmit update data in a state suitable for data transfer by an over-the-air (OTA) or a data transfer tool in a vehicle maintenance factory. In addition, it is possible to perform the encryption processing of update data in a state suitable for the encryption processing.

In the ECU 1, the update data may be subjected to the encryption processing after being subjected to the compression processing. The calculation unit may acquire the update version data block by decrypting and then decompressing the update data. As a result, it is possible to perform the compression processing that can obtain a higher compression effect the decryption processing and the decompression processing suitable for the update data subjected to the encryption processing.

In the ECU 1, the update data may include one or more of data blocks. Supplementary information of the data block may be described at a head or a tail or a position between the head and the tail of the data block. The address list may describe a position of a head of the data block or describe a position of the supplementary information arranged at a head of the data block. When the retransmission request address is located at the head of each data block, retransmission and rewriting of necessary data can be performed by resuming the write processing from the retransmission request address.

In the ECU 1, the update data may include a second data block next to a first data block. When a process of writing the second data block to the storage unit is interrupted in a middle after the first data block is written to the storage unit, the calculation unit may resume the process of writing the update data to the storage unit from the second data block. Since the write processing is restarted from the second data block next to the first data block for which the write processing has been completed, data transmission and writing can be minimized, and efficient write processing can be performed.

In the ECU 1, the electronic control device further includes: a memory that stores write completion block information indicating that writing of the data block of the update data to the storage unit is completed. Each time a data block of the update data is written in the storage unit, the calculation unit may store the write completion block information related to the data block in which writing is completed in the memory. When the write completion block information indicates that the writing of the second data block to the storage unit is not completed, the calculation unit may resume the process of writing the update data to the storage unit from the second data block. When the write processing is resumed, it is possible to easily specify from which data block the write should be resumed by referring to the write completion information in the data flash.

In the ECU 1, the calculation unit may be configured to diagnose whether the update data is normally written to the storage unit according to the write completion block information. By performing the abnormality determination of the write processing, it is possible to perform safer write processing, that is, program data update processing.

In the ECU 1, the vehicle may be configured to include a gateway device that temporarily stores the update data and transfers the temporarily stored update data to the electronic control device. The communication unit may receive the update data via the gateway device. When resuming the write processing interrupted in a middle, the calculation unit may re-acquire the update data temporarily held by the gateway device. After the update data is temporarily stored in the gateway, communication between the update data transmission unit 2 and the vehicle becomes unnecessary, so that the update processing of the program data can be performed regardless of the communication state. In addition, since the update data stored in the gateway is used when the write processing is resumed, there is no need to perform communication between the electronic terminal and the vehicle again.

In the ECU 1, a first data block included in the update data may be encrypted by using a second data block that is included in the update data and is different from the first data block. The update data may include an initialization vector used to decrypt a data block encrypted first in the update data. When the second data block is a data block encrypted first in the update data, the calculation unit may acquire the second data block and the initialization vector together to decrypt the second data block. When the first encrypted block is written, the decryption processing can be appropriately performed by transmitting an initialization vector necessary for the decryption processing performed before the write processing.

In the ECU 1, a first data block included in the update data may be encrypted by using a second data block that is included in the update data and is different from the first data block. The update data may include an initialization vector used to decrypt a data block encrypted first in the update data. The first data block may be arranged after the second data block in the update data, When decrypting the first data block, the calculation unit may decrypt the first data block by acquiring the first data block and the second data block together. In a case where the second and subsequent encrypted blocks are written, another block is required at the time of the decryption processing, and thus the decryption processing can be appropriately performed by transmitting this block together.

### MODIFICATIONS OF PRESENT INVENTION

The present invention is not limited to the above embodiments, but various modifications may be contained. For example, the above-described embodiments of the present invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

In the above embodiment, data to be written to the nonvolatile memory 15 or the flash memory 17 may be kept compressed. In this case, when the CPU 12 uses the compressed data, the compressed data may be dynamically decompressed and temporarily stored in the RAM 13, and the decompressed data may be read from the RAM 13 and executed.

In the fourth embodiment, the microcomputer 11 that has received the update data 4 first may decrypt the update data 4 and then transmit the decrypted data to the other microcomputer 11, or each microcomputer 11 may transmit the update data 4 as it is to the other microcomputer 11 and decrypt the update data 4 by itself.

### REFERENCE SIGNS LIST

1 ECU
11 microcomputer
12 CPU
13 RAM
14 communication unit
15 nonvolatile memory
16 serial communication unit
17 flash memory
18 inter-microcomputer communication unit
2 update data transmission unit
3 update data
31 global header
321 to 3N1 local header
322 to 3N2 body
4 update data
42 to 4N encrypted data block
5 data relay ECU

1. An electronic control device mounted on a vehicle, the electronic control device comprising:
a calculation unit configured to execute a program in which a process of controlling a device mounted on the vehicle is mounted;
a communication unit configured to receive update data used to update the program; and
a storage unit configured to store the program,
wherein
the update data includes at least one of compressed data subjected to compression processing or encrypted data subjected to encryption processing, and includes non-processed data not subjected to compression processing or encryption processing,
the calculation unit extracts an update version data block of the program to be written to the storage unit from the update data by at least performing one of decompressing the compressed data and decrypting the encrypted data,
the non-processed data holds an address list describing information capable of specifying each data block included in the update data,
when the process of writing the update version data block to the storage unit is interrupted in a middle, the calculation unit specifies a data block in the update data corresponding to the update version data block to be rewritten according to the address list, and designates the specified data block to re-acquire the update data.

2. The electronic control device according to claim 1, wherein
the non-processed data includes a header portion of a head of the update data,
the address list is included in the header portion, and
the calculation unit acquires the address list from the header portion to specify a data block in the update data corresponding to the update version data block to be rewritten.

3. The electronic control device according to claim 2, further comprising a memory that stores the address list,
wherein
the calculation unit stores the address list acquired from the header portion in the memory when writing the update version data block in the storage unit, and
the calculation unit specifies a data block in the update data corresponding to the update version data block to be rewritten using the address list stored in the memory when a process of writing the update version data block into the storage unit is interrupted in a middle.

4. The electronic control device according to claim 1, wherein
the update data includes one or more data blocks,
the non-processed data includes a header portion at a head of the data block,
the address list is included in the header portion, and
the calculation unit acquires the address list from the header portion to specify a data block in the update data corresponding to the update version data block to be rewritten.

5. The electronic control device according to claim 4, wherein
the data block is subjected to the compression processing, and
a header portion of the data block is not compressed.

6. The electronic control device according to claim 5, wherein
the calculation unit acquires the update version data block by decompressing the update data for each data block, and
the calculation unit writes the update data into the storage unit for each update version data block.

7. The electronic control device according to claim 5, wherein
the update data is configured by aggregating one or more of the data blocks subjected to the compression processing and the header portion corresponding to the data block,
the update data is subjected to the encryption processing for each of the data blocks, and
the header portion is not encrypted.

8. The electronic control device according to claim 5, wherein
the update data is subjected to the encryption processing after being subjected to the compression processing, and
the calculation unit acquires the update version data block by decrypting and then decompressing the update data.

9. The electronic control device according to claim 1, wherein
the update data includes one or more of data blocks,
supplementary information of the data block is described at a head or a tail or a position between the head and the tail of the data block, and
the address list describes a position of a head of the data block or describes a position of the supplementary information arranged at a head of the data block.

10. The electronic control device according to claim 1, wherein
the update data includes a second data block next to a first data block, and
when a process of writing the second data block to the storage unit is interrupted in a middle after the first data block is written to the storage unit, the calculation unit resumes the process of writing the update data to the storage unit from the second data block.

11. The electronic control device according to claim 10, further comprising:
a memory that stores write completion block information indicating that writing of the data block of the update data to the storage unit is completed,
wherein
each time a data block of the update data is written in the storage unit, the calculation unit stores the write completion block information related to the data block in which writing is completed in the memory, and
when the write completion block information indicates that the writing of the second data block to the storage unit is not completed, the calculation unit resumes the process of writing the update data to the storage unit from the second data block.

12. The electronic control device according to claim 11, wherein the calculation unit diagnoses whether the update data is normally written to the storage unit according to the write completion block information.

13. The electronic control device according to claim 1, wherein
the vehicle includes a gateway device that temporarily stores the update data and transfers the temporarily stored update data to the electronic control device,
the communication unit receives the update data via the gateway device, and
when resuming the write processing interrupted in a middle, the calculation unit re-acquires the update data temporarily held by the gateway device.

14. The electronic control device according to claim 1, wherein
a first data block included in the update data is encrypted by using a second data block that is included in the update data and is different from the first data block,
the update data includes an initialization vector used to decrypt a data block encrypted first in the update data, and
when the second data block is a data block encrypted first in the update data, the calculation unit acquires the second data block and the initialization vector together to decrypt the second data block.

15. The electronic control device according to claim 1, wherein
a first data block included in the update data is encrypted by using a second data block that is included in the update data and is different from the first data block,
the update data includes an initialization vector used to decrypt a data block encrypted first in the update data,
the first data block is arranged after the second data block in the update data, and
when decrypting the first data block, the calculation unit decrypts the first data block by acquiring the first data block and the second data block together.
